(19) United States
(12) Patent Application Publication
(10) Pub. No.: US 2013/0334195 A1
(43) Pub. Date: Dec. 19, 2013

(54) TWO-PIECE HEATING UNIT FOR GLOVE

(71) Applicant: CHIEN-CHOU CHEN, TAINAN (TW)

(72) Inventor: CHIEN-CHOU CHEN, TAINAN (TW)

(21) Appl. No.: 13/525,528

(22) Filed: Jun. 18, 2012

(51) Int. Cl. H05B 3/02

(52) U.S. Cl. 219/211

(57) ABSTRACT

A two-piece heating unit for gloves is revealed. The two-piece heating unit for gloves includes a heating body and a thumb heating element independent from each other and respectively being fit into a main body and a thumb portion of a glove. Thereby the appearance of the glove is improved and the ergonomic design of the glove provides higher flexibility during movement of fingers.

### BACKGROUND OF THE INVENTION

1. Field of the Invention

The present invention relates to a two-piece heating unit for gloves, especially to a two-piece heating unit for gloves including a heating body and a thumb heating element disposed independently from each other to improve the aesthetic appearance and the flexibility of the gloves in use.

2. Description of Related Art

Refer to Taiwanese App. Pub. No. M310601, a pair of heated gloves is revealed. Although heating elements mounted in the heated gloves keep users warm in the cold, the heating elements are only arranged at a palm part and four parallel fingers. This is due to that the thumb points to the direction different from that of the rest four fingers when users' hands are moved freely. Once a heating element for the thumb connected to the heating elements of the rest four fingers is arranged. The eating elements are easy to get damaged once being drawn or pulled. Moreover, the flexibility of the fingers while operating equipment is restricted.

### SUMMARY OF THE INVENTION

Therefore it is a primary object of the present invention to provide a two-piece heating unit for gloves that not only improves aesthetic appearance of the gloves but also provides full flexibility in use.

In order to achieve the above object, a two-piece heating unit for gloves includes a heating body and a thumb heating element. The heating body consists of a palm part and an area composed of a forefinger part, a middle finger part, a third finger part, and a little finger part. The heating body is arranged with covering layers and a heating unit is disposed in the covering layers. The heating unit includes a high-impedance wire, a positive conductive wire, and a negative conductive wire. One end of the positive conductive wire and one end of the negative conductive wire are connected to two ends of the high-impedance wire respectively. The other end of the positive conductive wire and the other end of the negative conductive wire are extended out of the covering layers of the heating body.

The thumb heating element is disposed independently from the heating body and is including covering layers and a heating unit within the covering layers. The heating unit includes a positive conductive wire and a negative conductive wire connected to two ends of a high-impedance wire respectively. The other end of the positive conductive wire and the other end of the negative conductive wire are extended out of the covering layers of the thumb heating element.

In the two-piece heating unit for gloves of the present invention, the heating body and the thumb heating element are independent from each other and are respectively mounted into a main body and a thumb portion of a glove. The appearance of the gloves is improved, and the thumb and other fingers are moving more freely and are applying force more easily during movement by the ergonomic design. Thus the gloves have improved appearance and offer full flexibility while users wearing them and moving their fingers.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a front view of an embodiment according to the present invention;

FIG. 3 is an explosive view of another embodiment according to the present invention;

FIG. 4 is a front view of another embodiment according to the present invention;

FIG. 5 is a front view of a further embodiment according to the present invention.

### DETAILED DESCRIPTION OF THE PREFERRED EMBODIMENT

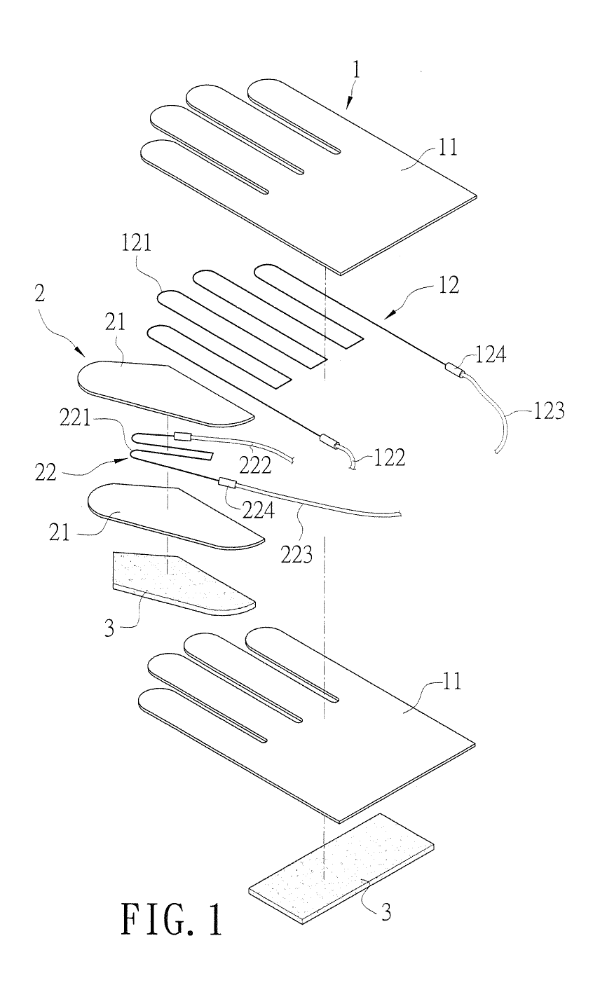

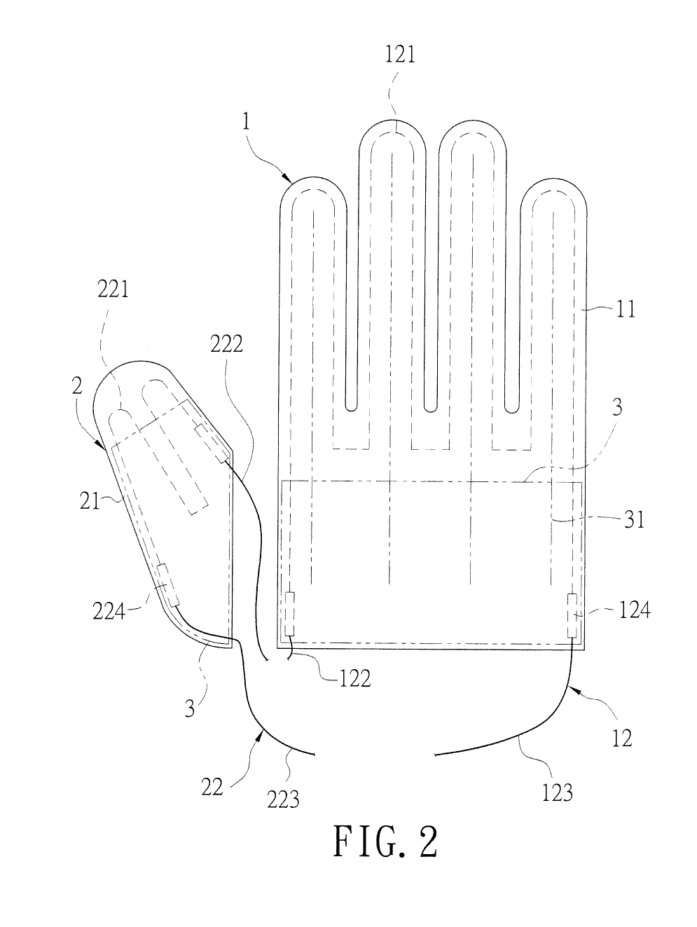

Refer to FIG. 1 and FIG. 2, a two-piece heating element for gloves of the present invention mainly includes a heating body 1, a thumb heating element 2, and at least two soft pads 3.

The heating body 1 consists of a palm part and an area connected to the palm part. The area is formed by a forefinger part, a middle finger part, a third finger part, and a little finger part. The forefinger part, the middle finger part, the third finger part, and the little finger part are arranged separately. The heating body 1 is disposed with covering layers 11 and a heating unit 12 that is mounted between the covering layers 11. The heating unit 12 includes a high-impedance wire 121, a positive conductive wire 122, and a negative conductive wire 123. The positive conductive wire 122 and the negative conductive wire 123 are connected to two ends of the high-impedance wire 121 respectively. The high-impedance wire 121 is arranged according to the shape of the palm part, the separate forefinger part, the middle finger part, the third finger part, and the little finger part so as to be used together with the thumb heating element 2 and assembled with five-finger gloves. A heat shrink sleeve 124 is disposed around one end of the positive conductive wire 122 that is connected to the high-impedance wire 121 and one end of the negative conductive wire 123 that is connected to the high-impedance wire 121 respectively. The other end of the positive conductive wire 122 and the other end of the negative conductive wire 123 are extended out of the covering layers 11 of the heating body 1.

The thumb heating element 2 is arranged independently from the heating body 1. The thumb heating element 2 includes covering layers 21 and a heating unit 22 clipped between the covering layers 21. The heating unit 22 is formed by a high-impedance wire 221, a positive conductive wire 222 and a negative conductive wire 223 connected to two ends of the high-impedance wire 221 respectively. The high-impedance wire 221 is disposed according to the shape of the thumb part. A heat shrink sleeve 224 is arranged at one end of the positive conductive wire 222 and one end of the negative conductive wire 223 respectively connected to the high-impedance wire 221. The other end of the positive conductive wire 222 and the other end of the negative conductive wire 223 are extended out of the covering layers 21 of the thumb heating element 2.

The soft pads 3 made from sponge are sewed outside the covering layers 11, 21 of the heating body 1 and the thumb heating element 2, covering over connections where the high-impedance wires 121, 221 are joined with the positive conductive wires 122, 222 and the negative conductive wires 222, 223 and wrapped around by the heat shrink sleeves 124, 224 respectively. The bottom side and the lateral sides of each soft pad 3 are sewed by using a continuous sewing thread 31. The high-impedance wire 121 of the heating body 1 includes a plurality of curved parts and a plurality of parallel parts. Moreover, some other sewing threads 31 are sewed between two adjacent parallel parts of the high-impedance wire 121.

While being assembled, refer to FIG. 1 and FIG. 2, the two soft pads 3 are respectively sewed onto the thumb heating element 2 and the heating body 1. Then the thumb heating element 2 is sewed in a thumb portion of a glove correspondingly and the heating body 1 is sewed into a main body of the glove. Next the thumb portion of the glove with the thumb heating element 2 is connected to the main body of the glove with the heating body 1 by sewing so as to form a glove. Moreover, the positive conductive wire 122 and the negative conductive wire 123 extending out of the heating body 1 and the positive conductive wire 222 and the negative conductive wire 223 extending out of the thumb heating element 2 are connected correspondingly and then are electrically connected to a controller and a power supply unit.

Thereby when the weather is cold or a user is in a cold place, the user can wear the glove disposed with the two-piece heating unit and turn on the controller to make the power supply unit output current. The current passes through the positive conductive wires 122, 222 and the negative conductive wires 123, 223 and flows to the high-impedance wire 121 of the heating body 1 as well as the high-impedance wire 221 of the thumb heating element 2. Due to high resistance of the high-impedance wires 121, 221, heat energy is generated and then is delivered through the heating body 1 and the thumb heating element 2 to protect user's hands against cold and keep them warm in the cold.

The heating body 1 and the thumb heating element 2 are separated from each other and fit into the thumb area and the main body of the glove independently. Such ergonomic design fits hand shape, not only improving the appearance of the gloves but also allowing the thumb and other fingers moving more fully and applying force more easily during movement. Thus full flexibility of user's hand is offered while wearing the glove and moving the fingers.

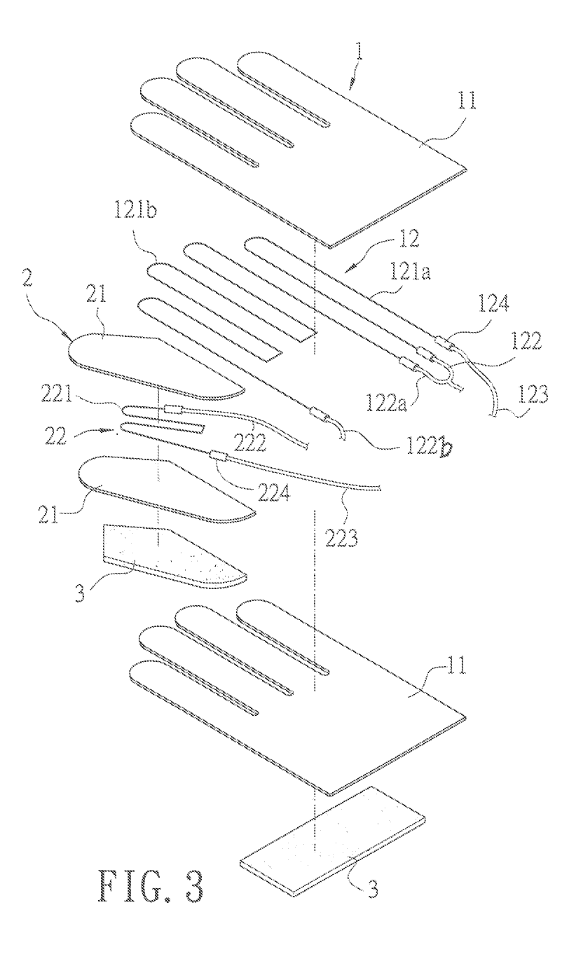

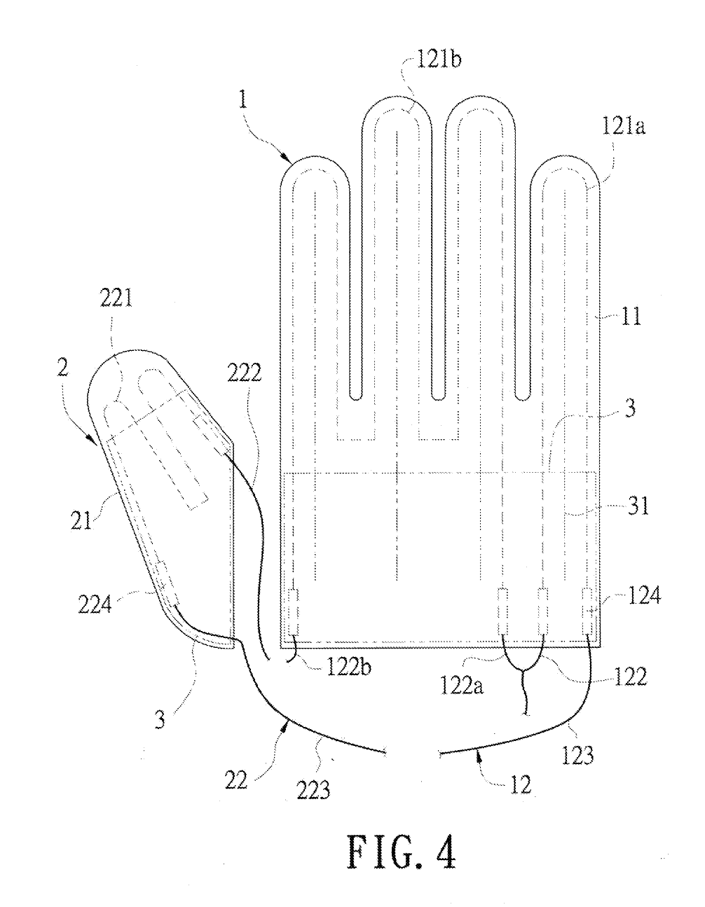

Refer to FIG. 3 and FIG. 4, how a high-impedance wire 121 of a heating body 1 and a high-impedance wire 221 of a thumb heating element 2 are respectively assembled with positive conductive wires 122, 222 and negative conductive wire 123, 223 is disclosed. A first high-impedance wire 121a and a second high-impedance wire 121b are disposed in the heating body 1. Two ends of the first high-impedance wire 121a are respectively connected to one end of the positive conductive wire 122 and one end of the negative conductive wire 123 while two ends of the second high-impedance wire 121b are respectively connected to one end of each positive conductive wire 122a. Moreover, two ends of the high-impedance wire 221 of a thumb heating element 2 are respectively connected to one end of the positive conductive wire 222 and one end of the negative conductive wire 223. The other end of the positive and the negative conductive wires 122, 122a, 123, 222, 223 of the heating body 1 and the thumb heating element 2 are extended out of the covering layers 11, 21 of the heating body 1 and the thumb heating element 2. Then the other end of the positive conductive wire 122 already connected to the first high-impedance wire 121a of the heating body 1 is connected to the other end of one of the positive conductive wires 122a joined with the second high-impedance wire 121b. The other end of the other positive conductive wire 122a joined with the second high-impedance wire 121b is connected to the other end of the positive conductive wire 222 of the thumb heating element 2. The other end of the negative conductive wire 123 already connected to the first high-impedance wire 121a of the heating body 1 is connected to the other end of the negative conductive wire 223 of the thumb heating element 2. Next after the positive and the negative conductive wires 122, 122a, 123, 222, 223 extending out of the heating body 1 and the thumb heating element 2 being connected correspondingly, they are electrically connected to a controller and a power supply unit. Thus a wiring assembly of the heating body 1 and the thumb heating element 2 in which the first high-impedance wire 121a and the second high-impedance wire 121b are arranged in the heating body 1 in parallel is provided.

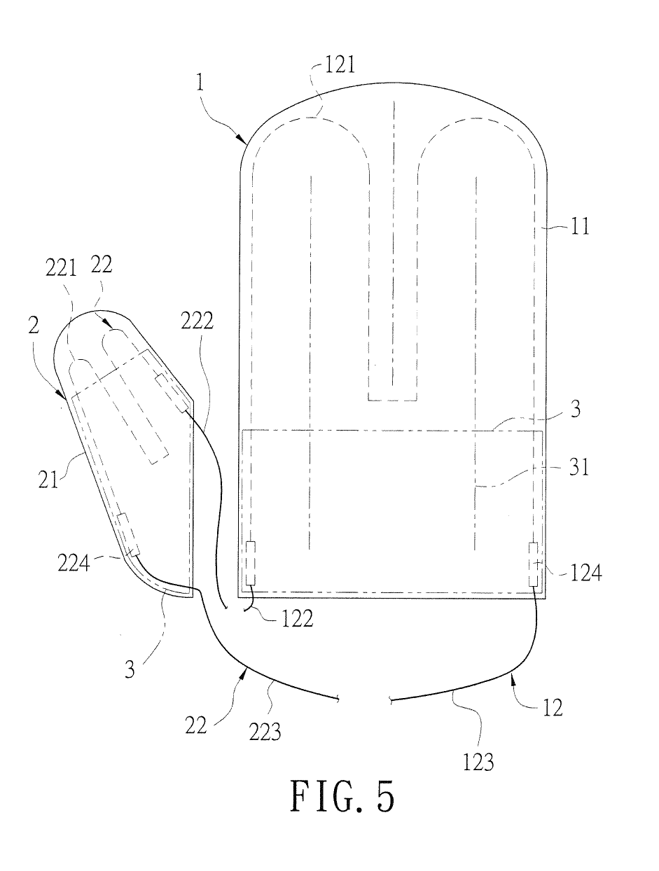

Refer to FIG. 5, a further embodiment is disclosed. A palm part, a forefinger part, a middle finger part, a third finger part, and a little finger part of a heating body 1 are integrated into one piece. And a high-impedance wire 121 is wound and arranged according to the one piece of the heating body 1 formed by the palm part, the forefinger part, the middle finger part, the third finger part, and the little finger part. The heating body 1 is mounted with at least one high-impedance wire 121 mentioned above or two high-impedance wires 121a, 121b. Thereby the heating body 1 together with a thumb heating element 2 is used as a main heating unit for mittens.

The soft pads 3 are sewed outside the covering layers 11, 21 of the heating body 1 and of the thumb heating element 2. By the soft pads 3 over connection areas between the high-impedance wires 121, 121a, 121b and positive conductive wires 122, 122a, 222/negative conductive wires 123, 223, projections formed by the connection area between the high-impedance wires 121, 121a, 121b and positive conductive wires 122, 122a, 222/negative conductive wires 123, 223 and the heat shrink sleeves 124, 224 therearound are covered. Thus users will not feel prickly or uncomfortable due to the projections. Therefore they can wear the gloves 1 of the present invention with flexibility and comfort for a long term.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A two-piece heating unit for gloves comprising:
a heating body, and a thumb heating element;
wherein the heating body includes a palm part, and an extension area, at least two covering layers, and a heating unit disposed in the covering layers; the extension area having a forefinger part, a middle finger part, a third finger part, and a little finger part; the heating unit includes a high-impedance wire, a positive conductive wire, and a negative conductive wire; of the positive conductive wire and the negative conductive wire is are respectively connected to two ends of the high-impedance wire and extend therefrom out of the covering layers of the heating body;
wherein the thumb heating element is arranged separate from the heating body, said thumb heating element and said heating body being independently displaceable one relative to the other; the thumb heating element includes at least two covering layers and a heating unit mounted in the covering layers; the heating unit having a high-impedance wire, a positive conductive wire and a negative conductive wire; the positive conductive wire and the negative conductive wire are respectively connected to two ends of the high-impedance wire and extend therefrom out of the covering layers of the thumb heating element.

2. The device as claimed in claim 1, wherein the two-piece heating unit for gloves further includes at least two soft pads that are sewed outside the covering layers of the heating body and the covering layers of the thumb heating element respectively; the soft pads are covered over each end of the high-impedance wire connected to the positive conductive wire and the negative conductive wire.

3. The device as claimed in claim 2, wherein a bottom side and lateral sides of each soft pad are sewed onto the heating body and the thumb heating element respectively by a continuous sewing thread; the high-impedance wire of the heating body having curved parts and parallel parts and a plurality of sewing threads are sewed between two adjacent parallel parts of the high-impedance wire of the heating body.

4. The device as claimed in claim 1, wherein the forefinger part, the middle finger part, the third finger part, and the little finger part of the heating body are connected to the palm part; the forefinger part, the middle finger part, the third finger part, and the little finger part are arranged separately; the high-impedance wire is arranged according to a shape of the palm part, the separate forefinger part, the middle finger part, the third finger part, and the little finger part.

5. The device as claimed in claim 1, wherein the palm part, the forefinger part, the middle finger part, the third finger part, and the little finger part of the heating body are integrated into one piece and the high-impedance wire is arranged according to a shape of the one piece.

6. A two-piece heating unit for gloves comprising:
a heating body, and a thumb heating element;
wherein the heating body includes a palm part, an extension area having a forefinger part, a middle finger part, a third finger part, and a little finger part, at least two covering layers, and a heating unit disposed in the covering layers; the heating unit includes a first high-impedance wire and a second high-impedance wire; two ends of the first high-impedance wire are respectively connected to one end of a positive conductive wire and one end of a negative conductive wire while two ends of the second high-impedance wire are respectively connected to one end of each of a first and a second positive conductive wire; the other end of each of the first and second positive conductive wires and the other end of each negative conductive wire are extended out of the covering layers of the heating body.
wherein the thumb heating element is arranged separate from the heating body, said thumb heating element and said heating body being independently displaceable one relative to the other; the thumb heating element includes at least two covering layers and a heating unit mounted in the covering layers; the heating unit having a high-impedance wire, a positive conductive wire and a negative conductive wire; the positive conductive wire and the negative conductive wire are respectively connected to two ends of the high-impedance wire and extend therefrom out of the covering layers of the thumb heating element.

7. The device as claimed in claim 6, wherein the two-piece heating unit for gloves further includes at least two soft pads that are sewed outside the covering layers of the heating body and the covering layers of the thumb heating element respectively; the soft pads are covered over each end of the first and second high-impedance wires.

8. The device as claimed in claim 7, wherein a bottom side and lateral sides of each soft pad are sewed onto the heating body and the thumb heating element respectively by a continuous sewing thread; the first and second high-impedance wires of the heating body having curved parts and parallel parts and a plurality of sewing threads are sewed between two adjacent parallel parts of the first and second high-impedance wires of the heating body.

9. The device as claimed in claim 6, wherein the forefinger part, the middle finger part, the third finger part, and the little finger part of the heating body are connected to the palm part; the forefinger part, the middle finger part, the third finger part, and the little finger part are arranged separately; the first and second high-impedance wires are is arranged according to a shape of the palm part, the separate forefinger part, the middle finger part, the third finger part, and the little finger part.

10. The device as claimed in claim 6, wherein the palm part, the forefinger part, the middle finger part, the third finger part, and the little finger part of the heating body are integrated into one piece and the first and second high-impedance wires are is arranged according to a shape of the one piece.

11. A two-piece heating unit for gloves comprising:
a heating body, and a thumb heating element;
wherein the heating body includes a palm part, and an extension area, at least two covering layers, and a heating unit disposed within the covering layers; the extension area having a forefinger part, a middle finger part, a third finger part, and a little finger part;
wherein the thumb heating element is arranged separate from the heating body, said thumb heating element and said heating body being independently displaceable one relative to the other; the thumb heating element includes at least two covering layers and a heating unit mounted in the covering layers.
